(19) United States
(12) Patent Application Publication
(10) Pub. No.: US 2021/0206001 A1
(43) Pub. Date: Jul. 8, 2021

(54) FULLY AUTOMATED COLUMBARIUM NICHE STORAGE SYSTEM

(71) Applicant: Chang Yup Lee, Los Angeles, CA (US)

(72) Inventor: Chang Yup Lee, Los Angeles, CA (US)

(21) Appl. No.: 16/737,875

(22) Filed: Jan. 8, 2020

(51) Int. Cl. B25J 15/00; G05B 19/042

(52) U.S. Cl. CPC B25J 15/0004; E04H 13/006; G05B 19/0425; B25J 15/0047

(57) ABSTRACT

A columbarium niche storage system includes a plurality of niche containers, which are stored in a three-dimensional array, one or more transportation devices that transport the niche containers, a control device that controls movements of and access to the niche containers, a storage structure that comprises storage spaces for storing the niche containers, and transportation tracks for the transportation devices, wherein the storage spaces comprise the three-dimensional array; and one or more viewing spaces. The transportation device comprises a horizontal linear movement device and a vertical linear movement device. The transportation device retrieves the niche container that was requested by a user of the viewing space from the storage space of the niche container and positions it into the viewing space for viewing by the user.

### BACKGROUND OF THE INVENTION

### 1. Field of the Invention

The present invention is related to a fully automated columbarium niche storage system.

### 2. Discussion of Related Technology

In a typical traditional columbarium facility, access to all niches are necessary from the aisle and thus require significant portion of the building footprint to aisles accessing the niches which can only be positioned in a single row for access to the niches. Positions of the niches range from bottom rows which are not easily accessible and to the top rows which make it nearly impossible to access without using a ladder. Each row of niches requires an access aisle for the family member(s) to access the loved one's niches and these niches cannot be stacked behind other niches in multiple layers because access to the niches stacked behind the front row niches is not possible. Due to the difference of accessibility of the niches in the traditional columbarium facility, positions of the niches at eye level are the most expensive niches. There have been other attempts in the past via several inventions to achieve the maximum space efficiency, but failed to address all niches having the equal access viewpoints and positioning of the niche for uniform accessibility.

The foregoing discussion in this section is to provide general background information, and does not constitute an admission of prior art.

### SUMMARY OF THE INVENTION

An objective of the invention is to provide an automated columbarium niche storage system that saves space and provides unique and enhanced commemoration experience to the family of the deceased.

In order to achieve the objective, the present invention provides a columbarium niche storage system comprising: a plurality of niche containers, which are stored in a three-dimensional array; one or more transportation devices that transport the niche containers; a control device that controls movements of and access to the niche containers; a storage structure that comprises storage spaces for storing the niche containers, and transportation tracks for the transportation devices, wherein the storage spaces comprise the three-dimensional array; and one or more viewing spaces. The transportation device comprises a horizontal linear movement device and a vertical linear movement device. The transportation device retrieves the niche container that was requested by a user of the viewing space from the storage space of the niche container and positions it into the viewing space for viewing by the user.

The control device authenticates the user to allow viewing the niche container that the user requested and controls the transportation device to retrieve the niche container from the storage space that stores the niche container and to transport the niche container from the storage space to the viewing room at which that the user waits the niche container.

The control device designates a storage space for the niche container in the viewing room and controls the transportation device to move the niche container from the viewing room to the storage space. The control device designates the storage space for the niche container by a predetermined priority for the niche container whereby retrieving time reduces as the priority rises.

The control device calculates retrieving time based on time needed for the transportation device to move the niche container between the viewing room and the storage space.

The control device calculates retrieving time based on number and length of horizontal segment(s) and vertical segments(s) that the niche container moves between the viewing room and the storage space. The number and length of horizontal segment(s) are represented by number of columns 1, number of rows w between the viewing room and the storage space in the three dimensional array, and the number and length of vertical segments(s) are represented by number of levels h between the viewing room and the storage in the three dimensional array.

The transportation device further comprises a grabbing device that positions the niche container on the transportation device. The control device controls the grabbing device to put the niche container on a predetermined location in the viewing room; waits predetermined time to allow the user to view inside of the niche container; controls the grabbing device to remove the niche container from the viewing room after the predetermined time is over.

The viewing room comprises a niche display cubicle. The niche display cubicle comprises a turn table on which the niche container is placed and a retractable wall that allows access of the niche container in the niche display cubicle by the grabbing device.

The storage system further comprises a queuing area connected to the viewing room(s) in which a plurality of niche containers may be queued whereby the operation of the transportation device for retrieving the niche containers may be performed in batch.

The advantageous effects of the present invention are: (1) the niches in the automated columbarium system all have the equal status at the eye level in the viewing area regardless of its storage position in the columbarium system; (2) all niches have the equal access viewpoints; (3) maximum space efficiency is achieved; (4) all niches are positioned for uniform accessibility; (5) individualized private moment in a private room setting or in the viewing aisle solely dedicated to one niche display with the family member(s) is available to everyone on an equal term; (6) time and energy for retrieving the more frequently requested niche containers are saved due to the priority based storage space designation; and (7) when there is high demand, viewing requests can be satisfied back to back.

### BRIEF DESCRIPTION OF THE DRAWINGS

The accompanying drawings illustrate the best embodiments of the present invention. In the drawings:

FIG. 1 is a flow diagram showing logical sequence control;

FIG. 2 is a schematic perspective view showing a fully automatic columbarium storage facility;

FIGS. 3(a), 3(b), 3(c) are schematic perspective views showing viewing rooms and a viewing wall;

FIG. 4 is a schematic plan view showing a columbarium modular unit;

FIG. 5 is a sectional view showing a columbarium storage behind the viewing area;

FIG. 6 is a side elevation view of the columbarium storage facility.

FIG. 7(a) and FIG. 7(b) are elevation views showing niche display walls;

FIG. 8 is a perspective view showing a niche container;

FIG. 9 is an elevation view of the inside of a viewing room;

FIG. 10 is a schematic elevation view of a transportation device;

FIG. 11 is a schematic side elevation view of a niche display cubicle area;

FIG. 12 is a block diagram showing elements controlled by a control device; and

FIG. 13 is a schematic perspective view showing the path between a viewing room and a storage space for a niche container.

### DESCRIPTION OF PREFERRED EMBODIMENTS

Embodiments will be described in detail below. The accompanying drawings will be used for describing embodiments. For the sake of convenience of illustrating embodiments, thickness, length, diameter, size and other dimensions of components would be illustrated or exaggerated to be different with those of actual components, and the subject matter of this application is not limited to the illustrated embodiments.

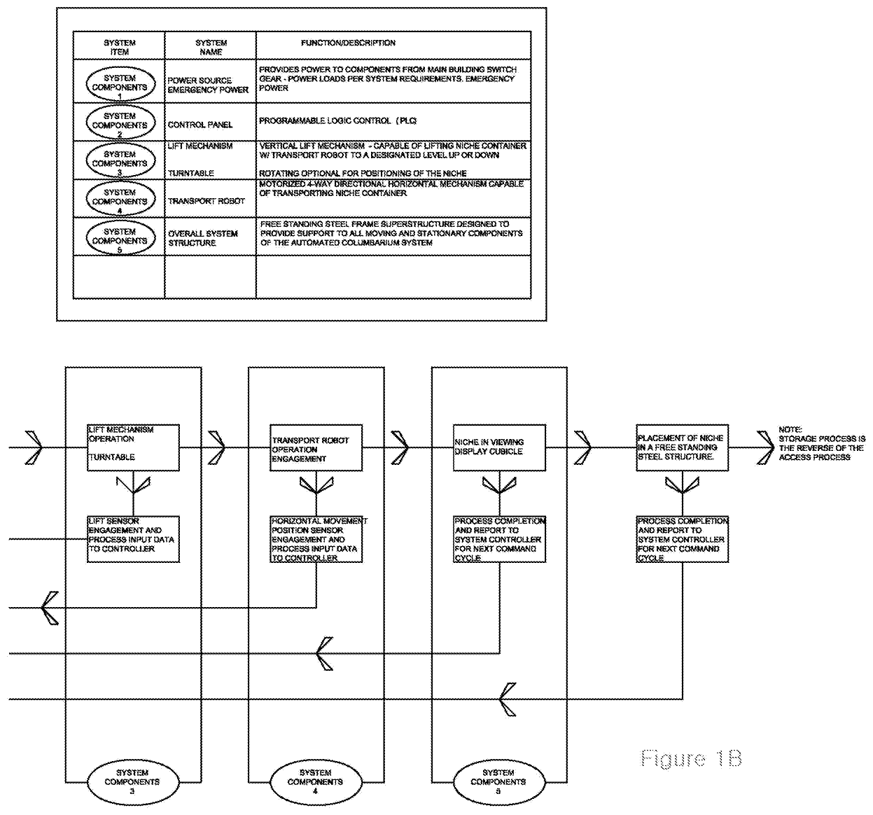

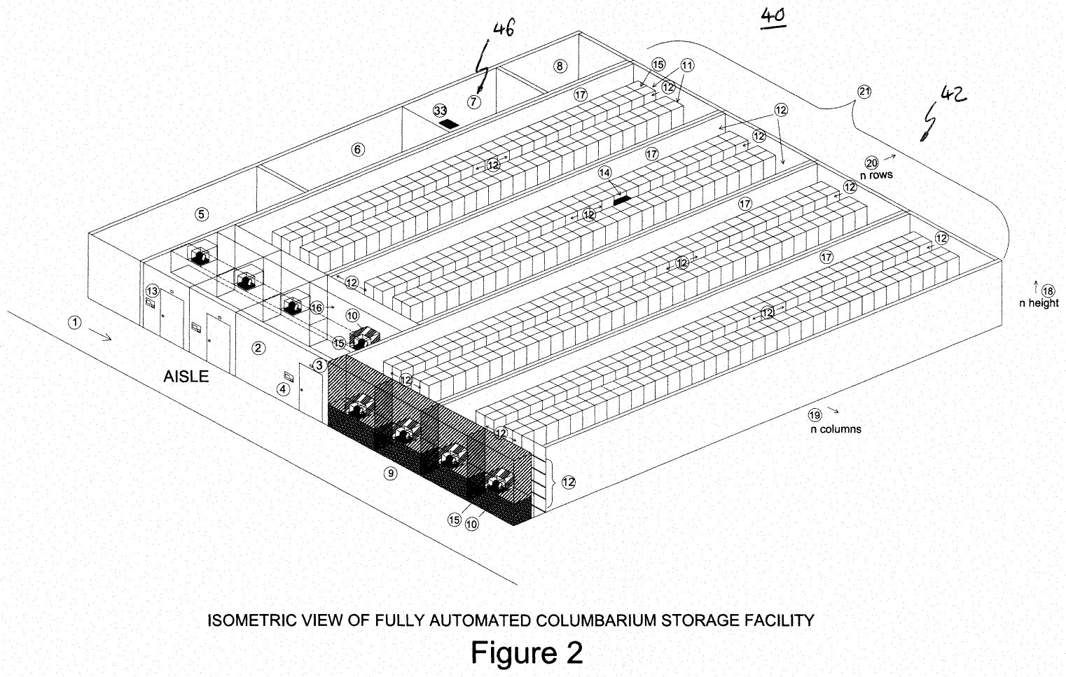

As shown on FIG. 2, the fully automated niche storage in columbarium with automated robotic transport system could be custom designed to store n number of rows and n number of columns of columbarium niches in n width×n length×n height space depending on the area and height of the available storage building. The individually designated and identified niche which holds the deceased individual's urn and unique personal memorabilia is stored and retrieved to the viewing room/viewing aisle using the electronic retrieval identification system.

The preassigned niche containing urn is transported with the fully automated Programmable Logic Control (PLC) command system, robotic transport mechanism, and lift system with an optional turntable to the viewing room (access location) from a predesignated cell inside the rack and rail steel (or composite material) super structure with efficiency and convenience, to provide storage and retrieval of individual niche on demand triggered by the manual keypad entry or with the keycard (or keyfob) issued to a registered user. The orientation of storage container is programmed to rotate on a turntable if necessary (depending on the design, turntable might not be necessary) during vertical movement of the lift mechanism to position the niche for proper positioning of the niche during the retrieval sequence. At the conclusion of niche viewing, system could be activated by the keycard or at conclusion of the preprogrammed viewing time to return the niche to its predesignated cell location. The PLC system which is the central command control keeps track of the location of the niche storage container at all times and its predetermined user information.

The individual niche container is transported to the viewing room or in the viewing aisle for eye level viewing in the case of aisle access viewing depending on the facility design option (viewing aisle or viewing room) for a private viewing with the family by playing the video/pictures of the loved one that are pre-programmed to engage as soon as the family member(s) engage the system to enter the viewing room or in front of the viewing space in the aisle. The viewing area whether in the aisle or in the private viewing room accesses/displays only one niche at a time for viewing for a programmed time span while other niches are safely stored in the storage area not accessible to public.

The niche storage container is uniform in its overall dimension and size. The number of niche storage is determined by the size of the columbarium which holds the niches. There is a basic modular unit size of the automated columbarium system and it could be custom designed to fit number of modules within the parameter of overall columbarium facility dimension.

The fully automated multi-directional robotic transport system of the present invention allows users to store and retrieve their loved one's urn (niche) in a niche container from/to a pre designated storage cell. Predetermined (authorized/ownership of niche and cell space) users have access to individual niche containers which are transported on user's command via automated transport system consisting of lift, turntable (optional) and robotic transport mechanism into the viewing area for efficient, convenient and easy storage/retrieval of niches inside the columbarium facility.

The automated columbarium niche storage system eliminates the need of the multiple access aisles thus utilizing most of the columbarium facility area footprint for the niche storage purposes except for the area need for common use of the viewing room or the access aisle and the maintenance aisles. This concept would allow columbarium facilities to accommodate more niches (multiple times of capacity) storage capabilities and thus serving the general public with much needed niche spaces in already crowded/over capacitated existing columbarium facilities to expand their niche storage capabilities without increasing the building size footprint. With the automated columbarium system, all niches are provided with the same access, positioning and individual privacy without any prejudice. All niches are considered equal in an automated columbarium system.

This invention combines the vertical lift component with optional turntable feature, horizontal component (four-directional lateral movement robot), effective container retrieval mechanism and providing multiple number of viewing rooms and viewing sections for the aisles as needed for user efficiency and convenience.

The fully automated columbarium system consists of eight main components:
1. Accessible area known as Private Viewing Room or Aisle Viewing Wall
2. Electronic recognition via code or cardkey or QR Code or Barcode
3. Positioning System (Laser Position Sensors)
4. Main PLC Control System
5. Lift System with a turntable (optional) capability
6. 4-way Directional Transport Robot with a niche container securing mechanism
7. Niche Storage Containers
8. Steel Rack and Rail System (Alternative equivalent strength composite material could be used)

Upon electronic activation by the authorized user, the fully automated columbarium system takes the niche container from the viewing room or the viewing aisle after the private family viewing on a transport robot mechanism (grabber) to transfer the niche container laterally (E-W direction) to the vertical lift (up-down) to take the niche container to a designated level, then transport robot moves the niche laterally (E-W direction) in front of the designated cell. When it arrives at the designated spot guided by the laser position sensor, robot then moves (N-S direction) the niche container in in its cell for storage until further demand is instructed (retrieval demand by the user). Retrieval sequence is reversal of these steps.

The automated columbarium system is controlled by a customized software application (PLC, Programmable Logic Control) incorporated into the system. The time required to retrieve/store a niche container are dependent on how you choose to customize your system for the time allotted for customer to use the private viewing room or at the aisle viewing. The mechanical aspects themselves are relatively static. In other words, the time it takes once the niche container is in the viewing room to when it is placed in a final stored cell space or vice versa to retrieve the niche from the storage to the viewing area is predetermined.

The registered user(s) who owns the niche space will be issued a cardkey or a key fob or an access code for manual entry to allow immediate system access upon arrival in the viewing room by entering the code manually or swiping the cardkey in order to access the viewing room and immediately activates the system to retrieve the niche container to be placed on the designated spot inside the viewing room.

The Automated Columbarium System Accessibility
1. Limited number of users will have access to the automated columbarium system.
2. User registers at the columbarium management office to be an authorized user of the system.
3. User will be given a card key or a key fob and the access code to access the system.
4. User enters the columbarium facility to access the available viewing room (size of the rooms range of individual room to family size room) or accesses the niche in front of the independent viewing section in the aisle.
5. There will be a status indicator light above each viewing room door that will illuminate “in use” when occupied.
6. Find and locate the viewing room with the indicator light off to access the room.
7. User can also manually enter the access code assigned to each individual into the monitor next to the viewing room entry door.
8. The niche container arrives in the viewing room (rotated if necessary) to have the front of the niche container facing out towards user.
9. There will be multiple viewing rooms available for users to access. Number of viewing rooms is evaluated by the anticipated number of visitors but heavily dependent on the columbarium management's discretion.
10. The niche container storage area is not accessible to user nor general public. Only the maintenance personnel is allowed to access the niche storage area (back area).
11. User's interface with the niche is in the viewing room only.
12. The system will be programmed to allow users specified time (usually 30 min-1 hour) to access the viewing room.
13. If additional access time is required, it could be pre-programmed ahead of time by management to allow additional viewing time.
14. At the conclusion of viewing, user exits the viewing room and the system will automatically remove the niche container from the viewing room to put it back in its predesignated or newly designated cell location and be ready for the next user(s) to enter.

System Features
1. System comprises of lift system, 4-directional transport robot, turntable (optional), PLC controls, laser sensors, safety sensors, niche containers, steel (or composite) structures and rails.
2. Once the niche container is positioned on the transport robot, lift mechanism is guided by laser position sensor to take the container to a designated level.
3. After arriving at the designated level, transport robot laterally transports the niche container to its designated cell with a laser guidance.
4. Connection to emergency power generator is provided for operation of the niche system during the power outage to properly return the niche in its original or newly designated storage position so as not to leave the niche in the viewing area.

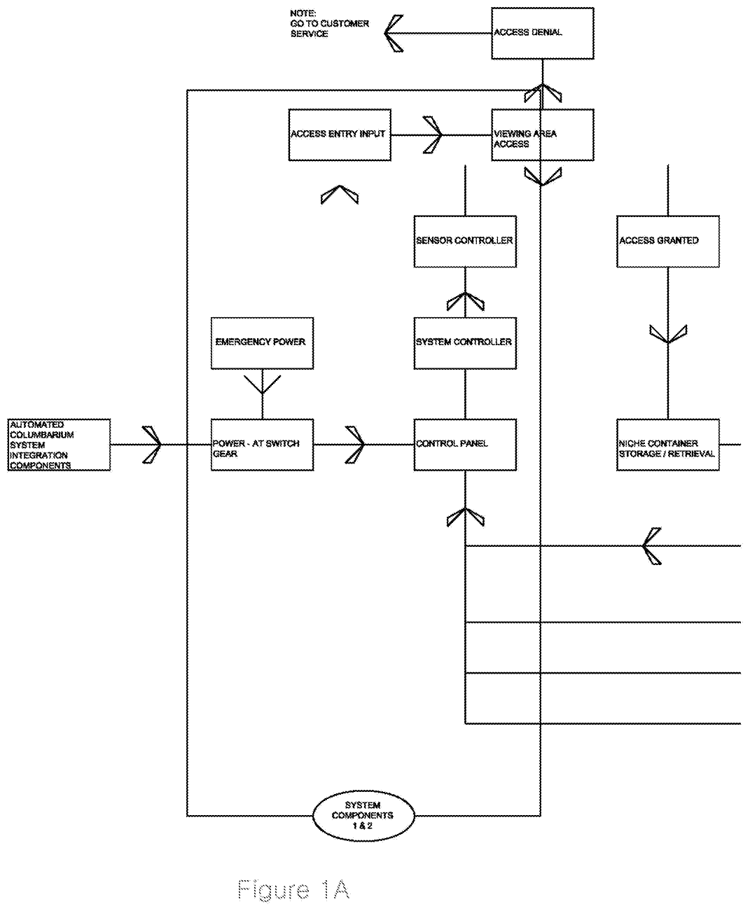

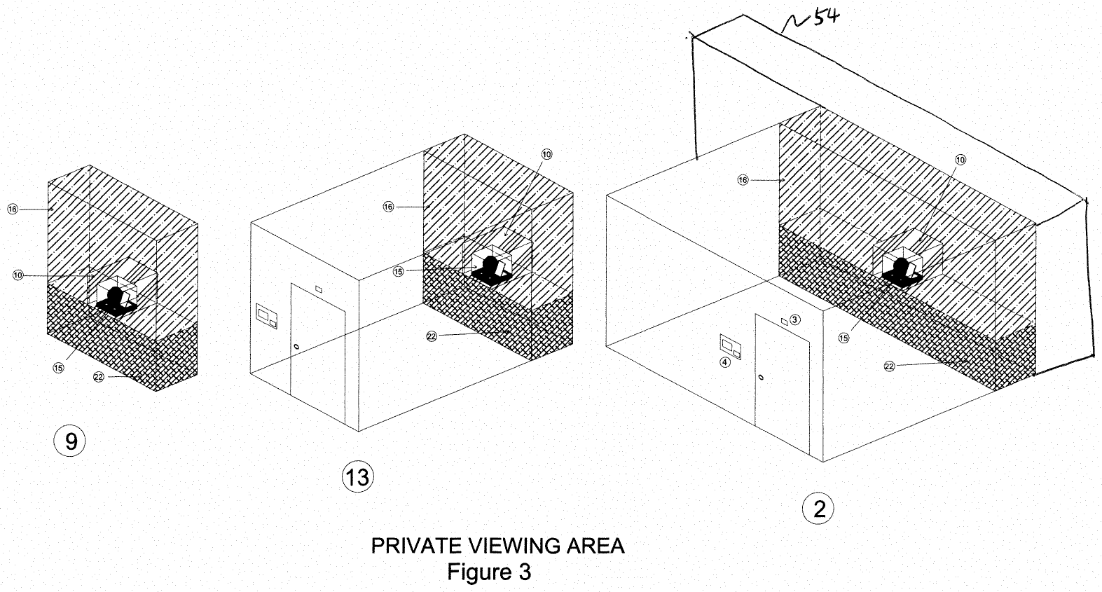

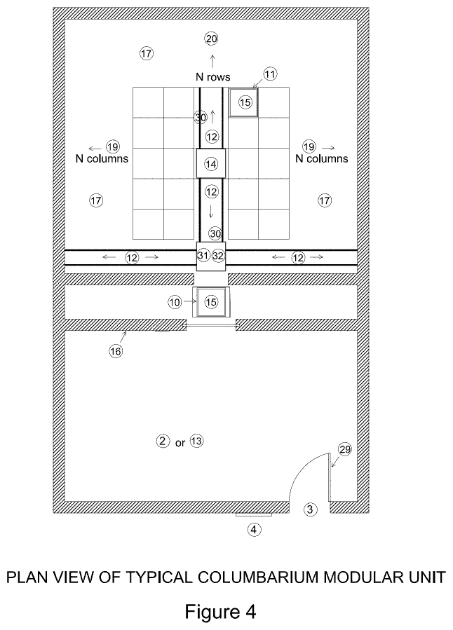

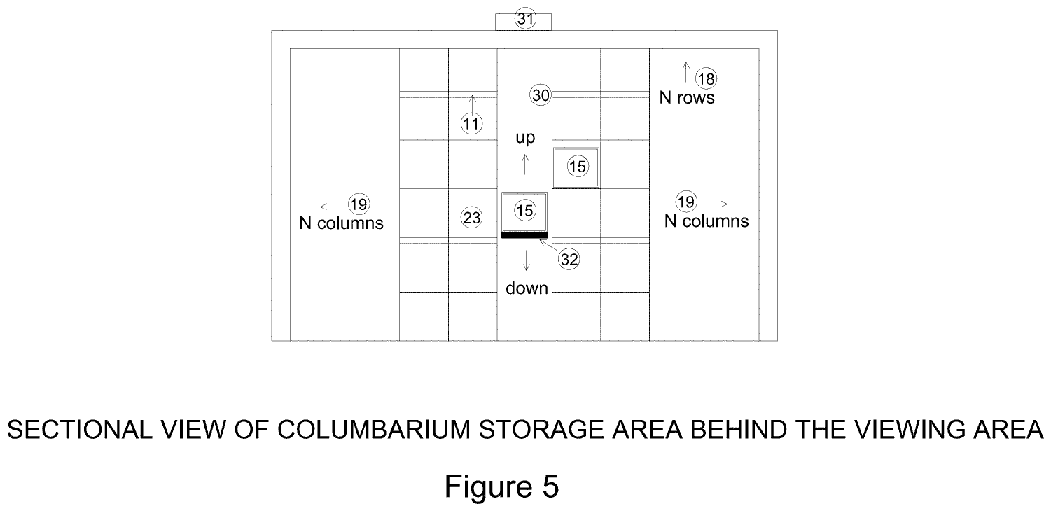

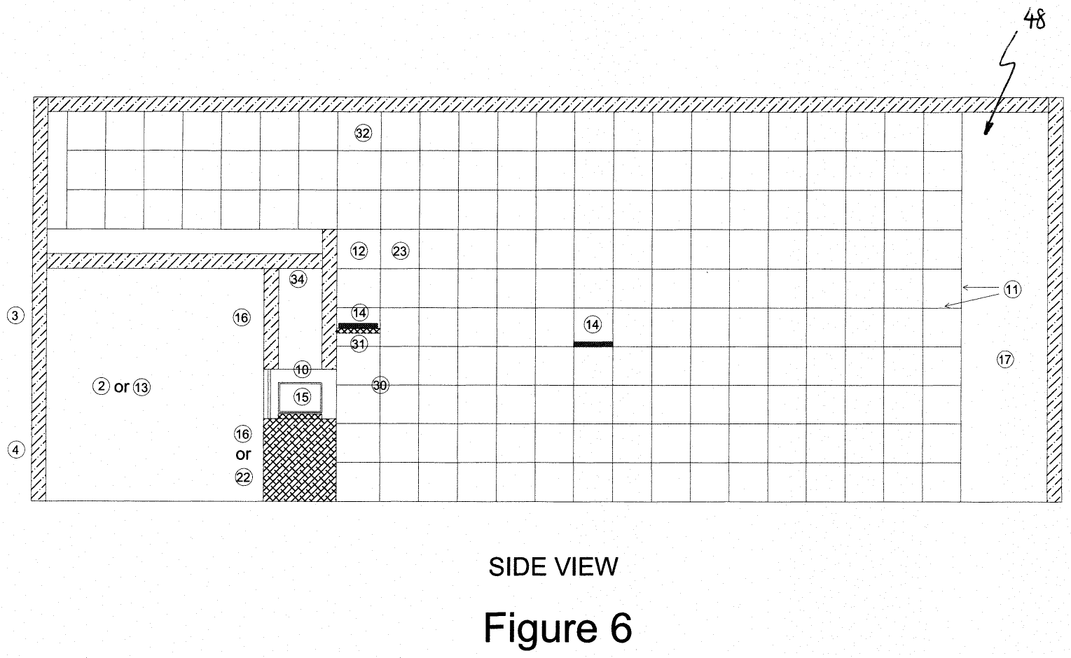

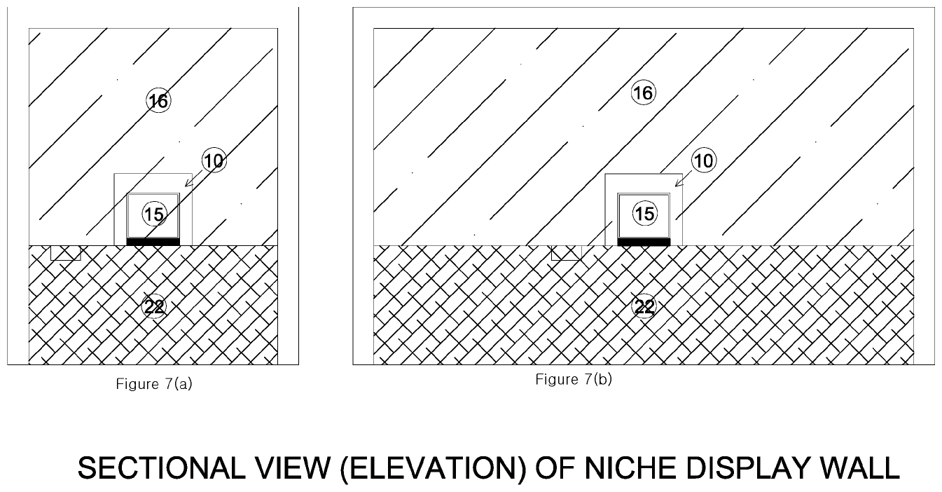

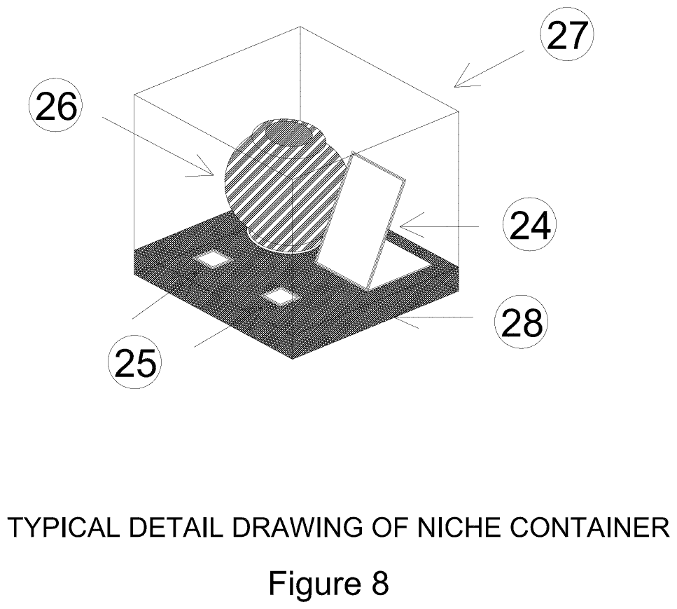

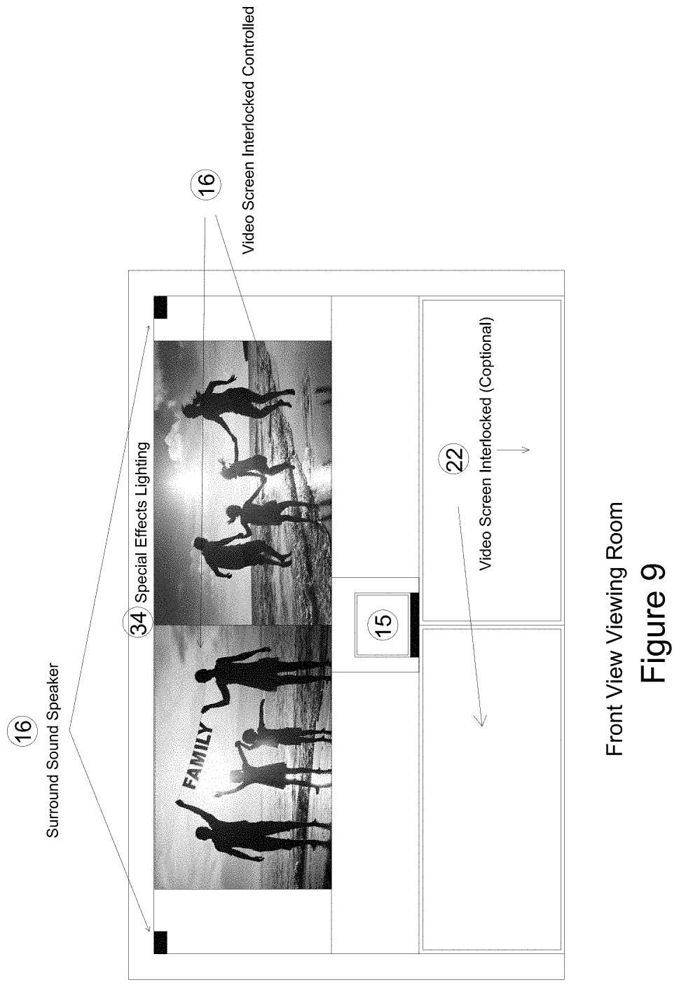

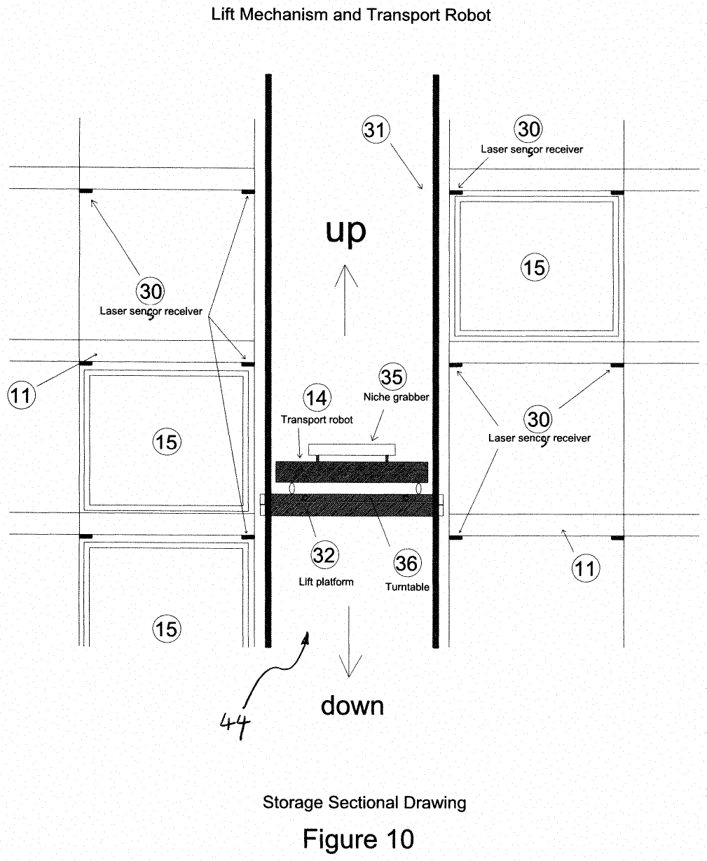

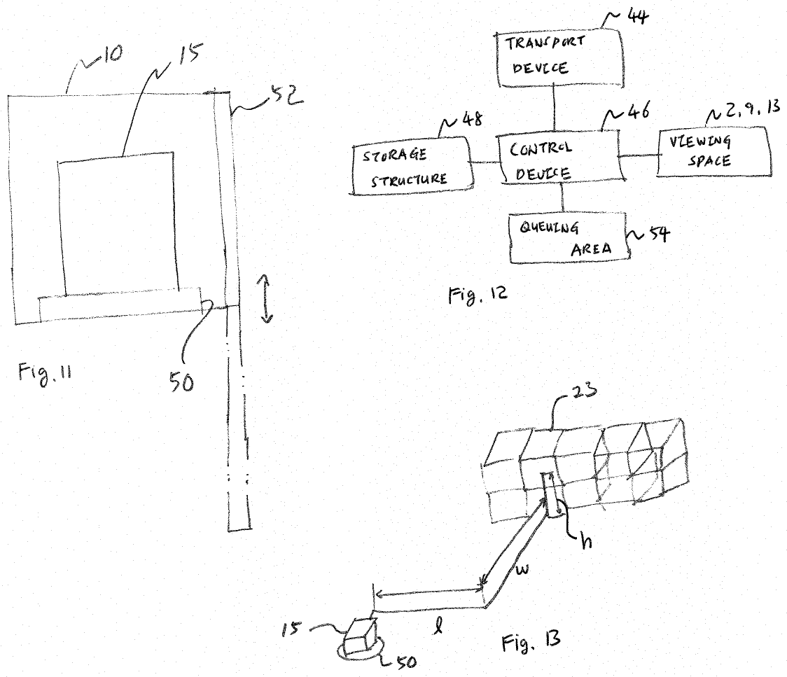

Detailed System Sequences
FIG. 1 illustrates the logical sequence of operational system control diagram.
FIG. 2 illustrates the isometric view layout of the overall columbarium facility and user access (1) of the facility whether it's private viewing rooms (2) (13) or private viewing access aisles (9) with the waiting area (5), management office (6) and equipment control room (7) (33) at the entrance of the columbarium viewing/viewing facility where user enters the manual access code or card key at the entry monitor pad (4) to access the viewing aisle area (9)/rooms (2) (13) with video screen (16) and niche holding cubicle (10). Storage steel (or composite) racks (11), horizontal access transport lanes (12), vertical lift (31) (32) with turntable (optional), lateral moving robot (14), steel rails (11) and niche containers (15) are situated in the rear of the columbarium facility with maintenance access aisles throughout (17). n level (18), n columns and n rows indicate the possible number of niche storage depending on the available building width, length and height.
FIGS. 3 (a)-3(c) illustrate the isometric view of private viewing rooms for family size room (2), individualized small size room (13) and aisle viewing (9) showing the position of niche display cubicle (10), niche container (15) and video screen area (16),(22).
FIG. 4 illustrates the plan view of the viewing rooms (2) (13) with video screen and sound system (16). Niche (15) arrives inside the niche viewing cubicle (10) for viewing by the loved ones. Entrance to the room is accessed at the monitor pad (4) and through the entry door (29) with the use indicator status light (3) above the entry door. The storage area footprint will be determined by the maximum number of rows (20) and maximum number of columns (19) inside the columbarium storage with maintenance aisles (17). Each level is equipped with lateral movement transport rails (12) for the transport robot (14) to travel in all four axis movement and up/down capabilities with the lift system (31) (32).
FIG. 5 illustrates the sectional view of the columbarium storage area behind the viewing display wall. The lift mechanism (31) (32) moves the niche (15) up and down to the designated storage level with the aid of position sensors (30) to place the niche in the preassigned storage cells (23) situated in the steel (or composite) structure (11).
FIG. 6 illustrates the side view of the columbarium storage area. The lift mechanism (32) moves the niche (15) up and down on the lift platform (31) to the designated storage level with the aid of position sensors (30) to place the niche in the preassigned storage cells (23) situated in the steel (or composite) structure (11).
FIG. 7(a) and FIG. 7(b) illustrate elevation (sectional) view of the niche display wall of the viewing access area for (2) (13) (9) with video screen (16), niche storage containers (15), niche container holding cubicle area (10). Lower section of the viewing wall (22) could be used as the video screen area (16).
FIG. 8 illustrates the niche container (15) with clear acrylic case cover (27) with the opaque solid base (28) to hold an urn (26), pictures (24) and memorabilia (25).
FIG. 9 illustrates the front view of the viewing room with detailed viewing screen system (16), lighting system (34) and audio system (16).
FIG. 10 illustrates the close up of the lift mechanism (31), turntable (36), lift platform (32) and the transport robot (14) and a grabber (35) in relationship to the niche storage rack system (11) equipped with laser position sensors (30).
FIG. 11 is a schematic side elevation view of a niche display cubicle area (10) with a turn table (50) and a retractable wall (52).
FIG. 12 is a block diagram showing elements controlled by a control device (46).
FIG. 13 is a schematic perspective view showing the path between a viewing room and a storage space for a niche container.

The present invention is explained in association with the elements of the claims. Referring to FIGS. 2 and 6, a columbarium niche storage system (40) comprises a plurality of niche containers (15), which are stored in a three-dimensional array (42); one or more transportation devices (44) that transport the niche containers (15); a control device (46) that controls movements of and access to the niche containers (15); a storage structure (48) that comprises storage spaces (23) for storing the niche containers (15), and transportation tracks (12) for the transportation devices (44), wherein the storage spaces (23) comprise the three-dimensional array (42); and one or more viewing spaces (2, 9, 13). Referring to FIG. 10, the transportation device (44) comprises a horizontal linear movement device (14) and a vertical linear movement device (31, 32). The transportation device (44) retrieves the niche container (15) that was requested by a user of the viewing space (2, 9, 13) from the storage space (23) of the niche container (15) and positions it into the viewing space (2, 9, 13) for viewing by the user.

The control device (46) authenticates the user to allow viewing the niche container (15) that the user requested and controls the transportation device (44) to retrieve the niche container (15) from the storage space (23) that stores the niche container (15) and to transport the niche container (15) from the storage space (23) to the viewing space (2, 9, 13) at which that the user waits the niche container (15).

Referring to FIGS. 12 and 13, the control device (46) designates a storage space (23) for the niche container (15) in the viewing space (2, 9, 13) and controls the transportation device (44) to move the niche container (15) from the viewing space (2, 9, 13) to the storage space (23). A storage space (23) for a particular niche container (15) needs not to be the same before and after the retrieving. It can be dynamically designated by the control device (46) each time after a particular niche container (15) is retrieved for viewing.

The control device (46) designates the storage space (23) for the niche container (15) by a predetermined priority for the niche container (15) whereby retrieving time reduces as the priority rises. A priority is given each time a new niche container (15) is stored in the system. New users and frequent users are given higher priority. This reduces overall moving distance of the niche containers (15). The control device (46) sets and adjusts the priority for the niche container (15), and designates a storage space (23) for the niche container (15) based on the priority.

The control device (46) calculates retrieving time based on time needed for the transportation device (44) to move the niche container (15) between the viewing space (2, 9, 13) and the storage space (23). The control device (46) calculates retrieving time based on number and length of horizontal segment(s) and vertical segments(s) that the niche container (15) moves between the viewing space (2, 9, 13) and the storage space (23).

The number and length of horizontal segment(s) are represented by number of columns 1, number of rows w between a particular viewing space (2, 9, 13) and a particular storage space (23) in the three dimensional array (42). The number and length of vertical segments(s) are represented by number of levels h between the viewing space (2, 9, 13) and the storage space (23) in the three dimensional array (42). Retrieving time is calculated based on length of the spatial path between the viewing space (2, 9, 13) and the storage space (23). In this way, the storage space (23) for a particular niche container (15) is dynamically designated according to the priority. Time to fill the storage spaces (23) in the columbarium would take many years. Frequency for viewing requests may widely vary per the niche containers (15) in the columbarium system (40). By giving priority, less frequently requested niche containers (15) can be positioned in storage spaces (23) farther from the viewing spaces (2, 9, 13), which save time and energy for retrieving the more frequently requested niche containers (15).

Referring to FIGS. 4 and 10, the transportation device further comprises a grabbing device (35) that positions the niche container (15) on the transport robot (14) of the transportation device (44). The control device (46) controls the grabbing device (35) ₜo put the niche container (15) on a predetermined location (10) in the viewing space (2, 9, 13), waits predetermined time to allow the user to view inside of the niche container (15), and controls the grabbing device (35) to remove the niche container (15) from the viewing space (2, 9, 13) after the predetermined time is over.

Referring to FIGS. 6 and 11, the viewing space comprises a niche display cubicle (10). The niche display cubicle (10) comprises a turn table (50) on which the niche container (15) is placed and a retractable wall (52) that allows access of the niche container (15) in the niche display cubicle (10) by the grabbing device (35). Rotation may be performed on the turntable (50) in the niche display cubicle (10). The retractable wall (52) hides the mechanism of the transportation device (44) and the storage structure (48) from users of the viewing space (2, 9, 13). The viewing space comprises one or more video screens and a sound system (16, 22). The control device controls the video screen and the sound system (16, 22) to play videos/pictures associated with the niche container (15) during the time that the user is inside the viewing space (2, 9, 13).

Referring to FIG. 3, the storage system further comprises a queuing area (54) connected to the viewing space(s) (2, 9, 13) in which a plurality of niche containers (15) may be queued whereby the operation of the transportation device (44) for retrieving the niche containers (15) may be performed in batch. Queuing may be desirable for certain timing during the year at which viewing requests are concentrated. In this way, viewing requests can be satisfied back to back. The control device (46) controls the transportation device (44) to store multiple niche containers (15) temporarily in the queuing area (54) in response to multiple requests to retrieve the niche containers (15) by multiple users of the viewing space (2, 9, 13).

The following table illustrates the list of itemized components in the FIGS. 1 through 13.
1. Entry to the Columbarium Facility
2. Family Size Private Viewing Room
3. “In Use” Indicator above Room Entrance Door
4. Entry Access Pad/Monitor. Code or Keycard or QR Code or Barcode recognition
5. Customer Waiting/Service Area
6. Management Office
7. Control Room for Programmable Logic Control Panel (PLC)
8. Restrooms
9. Columbarium Access Aisle (alternative to viewing rooms)
10. Niche Display Cubicle Area
11. Steel (Composite) Structures for transport rails and storage structure
12. Horizontal movement rails for transport robot
13. Individual (smaller) size Viewing Room
14. Transport Robot
15. Clear Niche Container
16. Viewing Video Screen and Sound System
17. Maintenance Personnel Access Aisle for Niche Service
18. Possible n levels of niches—System Height
19. Possible n number of columns—System Width
20. Possible n number of rows—System Depth
21. Back Area Niche Storage
22. Viewing Lower Wall or Extended Video Screen
23. Niche Container Storage Cell Space
24. Picture inside Niche Container
25. Memorabilia inside Niche Container
26. Urn
27. Clear Acrylic Niche Container Cover
28. Solid Niche Container Base (Wood)
29. Viewing Room Entrance Door
30. Typical sensors for both horizontal positions and vertical position sensors
31. Lift Mechanism
32. Lift Platform with optional turntable capability
33. Programmable Logic Control Panel
34. Special Effect Lighting
35. Niche Grabber on Transport Robot
36. Turntable on lift platform (optional)
40. Columbarium Niche Storage System
42. Three-Dimensional Array
44. Transportation Device
46. Control Device
48. Storage Structure
50. Turntable
52. Retractable Wall
54. Queuing Area

Although the automated columbarium niche storage system according to an exemplary embodiment of the present invention has been described in detail herein above, it should be understood that many variations and modifications of the basic inventive concept herein described, which may appear to those skilled in the art, will still fall within the spirit and scope of the exemplary embodiments of the present invention as defined by the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. A columbarium niche storage system comprising:
a) a plurality of niche containers, which are stored in a three-dimensional array;
b) one or more transportation devices that transport the niche containers;
c) a control device that controls movements of and access to the niche containers;
d) a storage structure that comprises storage spaces for storing the niche containers, and transportation tracks for the transportation devices, wherein the storage spaces comprise the three-dimensional array; and
e) one or more viewing spaces;
wherein the transportation device comprises a horizontal linear movement device and a vertical linear movement device,
wherein the transportation device retrieves the niche container that was requested by a user of the viewing space from the storage space of the niche container and positions it into the viewing space for viewing by the user.

2. The storage system of claim 1, wherein the control device authenticates the user to allow viewing the niche container that the user requested; controls the transportation device to retrieve the niche container from the storage space that stores the niche container and to transport the niche container from the storage space to the viewing space at which that the user waits the niche container.

3. The storage system of claim 2, wherein the control device designates a storage space for the niche container in the viewing space and controls the transportation device to move the niche container from the viewing space to the storage space.

4. The storage system of claim 3, wherein the control device designates the storage space for the niche container by a predetermined priority for the niche container whereby retrieving time reduces as the priority rises.

5. The storage system of claim 4, wherein the control device calculates retrieving time based on time needed for the transportation device to move the niche container between the viewing space and the storage space.

6. The storage system of claim 5, wherein the control device calculates retrieving time based on number and length of horizontal segment(s) and vertical segments(s) that the niche container moves between the viewing space and the storage space.

7. The storage system of claim 6, wherein the number and length of horizontal segment(s) are represented by number of columns 1, number of rows w between the viewing space and the storage space in the three dimensional array, and wherein the number and length of vertical segments(s) are represented by number of levels h between the viewing space and the storage space in the three dimensional array.

8. The storage system of claim 7, wherein the transportation device further comprises a grabbing device that positions the niche container on the horizontal linear movement device, wherein the control device controls the grabbing device to put the niche container on a predetermined location in the viewing space; waits predetermined time to allow the user to view inside of the niche container, controls the grabbing device to remove the niche container from the viewing space after the predetermined time is over.

9. The storage system of claim 8, wherein the viewing space comprises a niche display cubicle, wherein the niche display cubicle comprises a turn table on which the niche container is placed and a retractable wall that allows access of the niche container in the niche display cubicle by the grabbing device.

10. The storage system of claim 9, further comprising a queuing area connected to the viewing space(s) in which a plurality of niche containers may be queued whereby the operation of the transportation device for retrieving the niche containers may be performed in batch.

11. The storage system of claim 10, wherein the viewing space comprises one or more video screens and a sound system, wherein the control device controls the video screen and the sound system to play videos/pictures associated with the niche container during the time that the user is inside the viewing space.

12. The storage system of claim 11, wherein the control device controls the transportation device to store multiple niche containers temporarily in the queuing area in response to multiple requests to retrieve the niche containers by multiple users of the viewing space.
